(19) United States
(12) Patent Application Publication
(10) Pub. No.: US 2026/0112007 A1
(43) Pub. Date: Apr. 23, 2026

(54) METHOD OF CORRECTING KEYPOINT AND VEHICLE IMPLEMENTING THE SAME

(71) Applicants: Hyundai Motor Company, Seoul (KR); Kia Corporation, Seoul (KR)

(72) Inventors: Chan Sun SONG, Hwaseong-Si (KR); Deuk Hyeon KIM, Hwaseong-Si (KR); Tae Yong SONG, Hwaseong-Si (KR)

(73) Assignees: Hyundai Motor Company, Seoul (KR); Kia Corporation, Seoul (KR)

(21) Appl. No.: 19/346,173

(22) Filed: Sep. 30, 2025

(30) Foreign Application Priority Data
Oct. 23, 2024 (KR) 10-2024-0145732

(51) Int. Cl. G06T 5/80; B60W 60/00; G06V 10/44; G06V 10/62; G06V 10/77; G06V 20/58

(52) U.S. Cl. CPC G06T 5/80; G06V 10/44; G06V 10/62; G06V 10/7715; B60W 60/001; B60W 2420/403; B60W 2510/20; B60W 2520/10; B60W 2520/105; B60W 2552/53; B60W 2554/20; G06V 20/586

(57) ABSTRACT

A method of correcting keypoint and vehicle implementing the same, includes generating a bird's-eye view image based on image data that obtains a surrounding environment of a vehicle; generating keypoint information including a keypoint detected from a nearby object of the vehicle based on the bird's-eye view image; generating, in response to driving of the vehicle, a first movement amount identified by the keypoint information and a second movement amount identified by vehicle data generated by the driving of the vehicle; estimating a height of the keypoint in response to a deviation between the first movement amount and the second movement amount; and correcting the keypoint information based on the estimated height of the keypoint.

### CROSS-REFERENCE TO RELATED APPLICATION

The present application claims priority to and the benefit of Korean Patent Application No. 10-2024-0145732, filed on Oct. 23, 2024, the disclosure of which is incorporated herein by reference in its entirety.

### BACKGROUND

### Field of the Present Disclosure

The present disclosure relates to a method of correcting a keypoint and a vehicle implementing the same, and more specifically, to a method and vehicle for correcting a keypoint that improves the accuracy of path generation and autonomous driving performance through accurate estimation of the height of an object around the vehicle.

### Discussion of Related Art

Recently, vehicles equipped with autonomous driving functions tend to be commercialized for driving convenience. Autonomous driving functions are being developed so that fully autonomous driving in which a vehicle takes full driving control without driver intervention in any situation becomes a reality. Prior to the transition to fully autonomous driving, some functions of fully autonomous driving are being installed and utilized in commercial vehicles. In autonomous driving, not only general road driving but also autonomous parking may be implemented.

An autonomous driving-based vehicle may recognize the surrounding environment obtained by sensors, and furthermore, may acquire various types of data from inside and outside the vehicle, identify a situation around the vehicle based on the recognized surrounding environment and data, establish an autonomous driving strategy or control plan corresponding to the identified situation, and control actuators of the vehicle to drive according to the strategy.

In autonomous driving, spatial recognition may be performed based on the perceived surrounding environment. The present spatial recognition may utilize a keypoint generated based on, for example, bird's-eye view (BEV) images. BEV images are generated assuming that the ground on which a vehicle is present is flat (Z=0). However, in most actual parking spaces, the ground height is not 0. As a result, distortion is present in the BEV images, and an error occurs in a recognition result of a keypoint recognized from the BEV images. This generates an inaccurate path and reduces autonomous driving performance and autonomous parking functions.

### SUMMARY OF THE INVENTION

The present disclosure is directed to providing a method and vehicle for correcting a keypoint that improves the accuracy of path generation and autonomous driving performance through accurate estimation of the height of an object around the vehicle.

Technical problems to be solved in the present disclosure are not limited to the technical problems, which have been mentioned above, and other technical problems that are not mentioned will be clearly understood by those of ordinary skill in the art to which the present disclosure belongs from the following description.

According to an exemplary embodiment of the present disclosure, there is provided a method of correcting a keypoint, the method including: generating a bird's-eye view image based on image data that obtains a surrounding environment of a vehicle; generating keypoint information including a keypoint detected from a nearby object of the vehicle based on the bird's-eye view image; generating, in response to driving of the vehicle, a first movement amount identified by the keypoint information and a second movement amount identified by vehicle data generated by the driving of the vehicle; estimating a height of the keypoint in response to a deviation between the first movement amount and the second movement amount; and correcting the keypoint information based on the estimated height of the keypoint.

According to the exemplary embodiment of the present disclosure in the method, the nearby object may be a static object, and the keypoint may be generated at at least one of an end portion of the static object, an edge portion of the static object, a vertex of the static object, and an intersection located at a point where lines of different static objects meet.

According to the exemplary embodiment of the present disclosure in the method, the static object may be a road marking.

According to the exemplary embodiment of the present disclosure in the method, a keypoint coordinate system of the keypoint information may be different from an image coordinate system of the bird's-eye view image and may be a coordinate system established based on a predetermined part of the vehicle.

According to the exemplary embodiment of the present disclosure in the method, the generating of the keypoint information may include generating the keypoint information including the keypoint generated by detecting a feature point recognized from the nearby object of the bird's-eye view image and projecting the feature point onto a keypoint coordinate system. Also, the generating of the first movement amount in response to the driving of the vehicle may include: identifying a changed position of the feature point that corresponds to the keypoint and is changed in the bird's-eye view image by driving of the vehicle; projecting the changed position of the feature point onto the keypoint coordinate system to determine a changed position of the keypoint; and generating the first movement amount based on the changed position of the keypoint.

According to the exemplary embodiment of the present disclosure in the method, the vehicle data may include longitudinal information including speed, acceleration, and deceleration of the vehicle, lateral information related to steering of the vehicle, and attitude information related to an attitude of the vehicle.

According to the exemplary embodiment of the present disclosure in the method, the estimating of the height of the keypoint may include estimating the height of the keypoint for which the deviation is present in a keypoint coordinate system of the keypoint information based on the first movement amount, the second movement amount, the keypoint information related to the keypoint for which the deviation is present, and a feature point corresponding to the keypoint for which the deviation is present in the bird's-eye view image, and the height of the keypoint is estimated using either a trigonometric function model or a pinhole camera model.

According to the exemplary embodiment of the present disclosure in the method, the method may further include configuring the keypoint information without changing the height of the keypoint for which the deviation is absent, in response to absence of the deviation between the first movement amount and the second movement amount.

According to the exemplary embodiment of the present disclosure in the method, the generating of the keypoint information may include detecting a plurality of feature points recognized from the nearby object of the bird's-eye view image and generating the keypoint information to include a plurality of keypoints based on the plurality of feature points.

According to the exemplary embodiment of the present disclosure in the method, the bird's-eye view image may be generated so that all objects include the same height level in the image.

According to another embodiment of the present disclosure, there is provided a vehicle that implements keypoint correction, the vehicle including: a sensor unit configured to detect a surrounding environment of the vehicle; a memory configured to store at least one instruction for controlling the vehicle; and a processor configured to execute the at least one instruction stored in the memory. The processor is configured to: generate a bird's-eye view image based on image data that obtains the surrounding environment of the vehicle; generate keypoint information including a keypoint detected from a nearby object of the vehicle based on the bird's-eye view image; generate, in response to driving of the vehicle, a first movement amount identified by the keypoint information and a second movement amount identified by vehicle data generated by the driving of the vehicle; estimate a height of the keypoint in response to a deviation between the first movement amount and the second movement amount; and correct the keypoint information based on the estimated height of the keypoint.

The features briefly summarized above for the present disclosure are only exemplary aspects of the detailed description of the disclosure which follow, and are not intended to limit the scope of the disclosure.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view exemplarily illustrating a vehicle transmitting and receiving data by communicating with other devices;

FIG. 2 is a diagram showing modules constituting a vehicle according to one embodiment of the present disclosure;

FIG. 3 is a flowchart of a method of correcting a keypoint according to another embodiment of the present disclosure;

FIG. 4 is a view exemplarily illustrating an image of a surrounding environment obtained by a camera of the vehicle;

FIG. 5 is a view exemplarily illustrating a bird's-eye view image;

FIG. 6 is a view exemplarily illustrating keypoint information;

FIG. 7 is a view exemplarily illustrating a bird's-eye view image which is changed according to driving of the vehicle; and

FIG. 8 is a view exemplarily illustrating keypoint information including corrected keypoints.

### DETAILED DESCRIPTION OF EXEMPLARY EMBODIMENTS

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an exemplary embodiment of the present disclosure could be termed a second element in another embodiment, and similarly, a second element in an exemplary embodiment of the present disclosure could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an exemplary embodiment of the present disclosure composed of a subset of elements described in an exemplary embodiment of the present disclosure is also included in the scope of the present disclosure. In addition, embodiments including other elements in addition to the elements described in the various embodiments are also included in the scope of the present disclosure.

The advantages and features of the present disclosure and the way of attaining them will become apparent with reference to exemplary embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the invention to those skilled in the art.

In the present disclosure, each of phrases such as “A or B”, “at least one of A and B”, “at least one of A or B”, “A, B or C”, “at least one of A, B and C”, ““at Each of the phrases such as “at least one of A, B or C” and “at least one of A, B, C or combination thereof” may include any one or all possible combinations of the items listed together in the corresponding one of the phrases..

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

Hereinafter, embodiments of the present disclosure will be described with reference to the accompanying drawings.

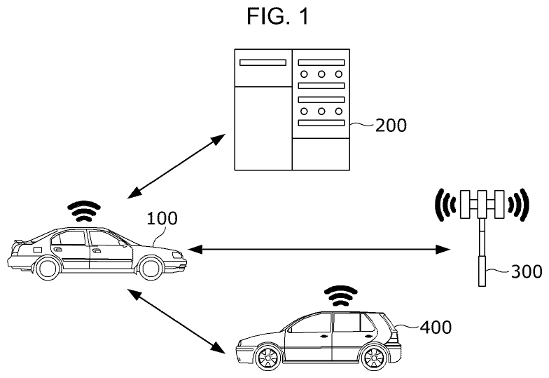

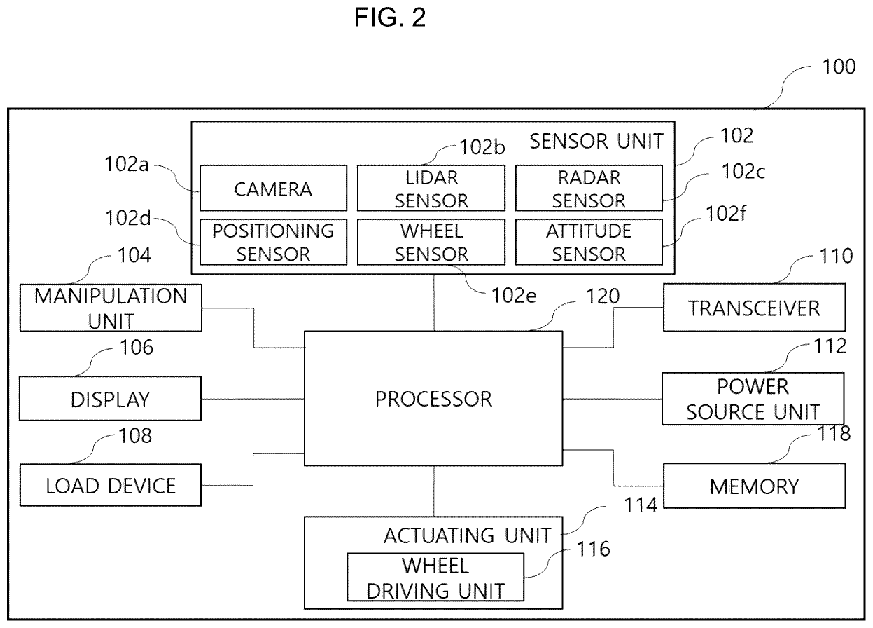

Hereinafter, with reference to FIGS. 1 and 2, a vehicle which is adaptively controlled depending on a road type according to a user's request or intention and incorporates at least some autonomous driving functions will be described. FIG. 1 is a view exemplarily illustrating a vehicle transmitting and receiving data by communicating with other devices.

Referring to FIG. 1, a vehicle 100 may be driven based on electrical energy or fossil energy. In the case of electrical energy, the vehicle 100 may be, for example, a pure battery-based vehicle driven only by a high-voltage battery, or may employ a gas-based fuel cell as an energy source. Furthermore, the fuel cell may use various types of gas capable of generating electrical energy, and the vehicle 100 may be filled with gas in a liquefied state, for example. Here, one example of the gas may be hydrogen. However, the gas is not limited thereto, and various gases are applicable. In the case of fossil energy, the vehicle 100 is driven based on fuel such as gasoline, diesel or liquefied gas, and may be disposed with an internal combustion engine that drives an actuating unit 114 by combustion of the fuel. The engine may be included in a power source unit 112 in terms of providing a driving rotation force of wheels to a wheel driving unit 116. As an exemplary embodiment of the present disclosure, the vehicle 100 may drive the actuating unit 114 by selectively utilizing energy from a fossil energy-based internal combustion engine and an electric battery, and may be a hybrid type vehicle.

The vehicle 100 may refer to a movable device. The vehicle 100 is a ground vehicle that travels on the ground and may be a typical passenger vehicle or commercial vehicle, a purpose-built vehicle (PBV), or the like. The vehicle 100 may be a four-wheeled vehicle, such as a passenger vehicle, a sports utility vehicle (SUV), or a small truck, or may be a vehicle with more than four wheels, such as a bus, a large truck, a container transport vehicle, a heavy equipment vehicle, or the like. The vehicle 100 may be a robot in a broad sense, such as a means of transportation, and the robot may move using wheels, tracks, or other movement modules.

The vehicle 100 may be controlled and driven by autonomous driving, and the autonomous driving may be implemented as semi-autonomous driving or fully autonomous driving. Fully autonomous driving may be provided as autonomous movement in which a processor 120 of the vehicle 100 takes full control without user intervention, even when a driving situation is uncertain. Semi-autonomous driving may be provided as autonomous movement that requires driver intervention depending on specific driving situations. The semi-autonomous driving may be implemented so that the processor 120 transfers control to a user by deactivating autonomous driving when the aforementioned situation occurs, allowing the user to perform manual driving. According to the levels of autonomous driving defined by the Society of Automotive Engineers (SAE), the semi-autonomous driving may correspond to autonomous driving levels 1 to 4, and the fully autonomous driving may correspond to level 5.

Meanwhile, the vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices, or the like. The server 200 may be, for example, an external device operated by a vehicle manufacturer or provided to service autonomous driving, and may receive connected data of the vehicle 100 or transmit data necessary for autonomous driving. The server 200 may transmit various pieces of information and software modules used to control the vehicle 100 to the vehicle 100 in response to requests and data transmitted from the vehicle 100 and the user device to support autonomous driving and various services of the vehicle 100.

The ITS device 300 is a type of external device, and may be, for example, a roadside unit (RSU). The ITS device 300 may assist the user in driving his or her vehicle or support autonomous driving of the vehicle 100 by exchanging vehicle recognition data, driving control and state data, environmental data around the vehicle, map data, or the like, through vehicle-to-infrastructure (V2I) communication with the vehicle 100. The vehicle 100 may support manual driving or autonomous driving by exchanging the data listed above through vehicle-to-vehicle (V2V) communication with the other vehicle 400.

The vehicle 100 may communicate with other vehicles or other devices based on cellular communication, wireless access in vehicular environment (WAVE) communication, dedicated short range communication (DSRC), short-range communication, or other communication methods.

For example, the vehicle 100 may use a cellular communication network such as LTE or 5G, a WiFi communication network, a WAVE communication network, or the like, for communication with the server 200, the ITS device 300, and the other vehicle 400. For another example, DSRC or the like used in the vehicle 100 may be used for communication between vehicles. The communication method between the vehicle 100, the server 200, the ITS device 300, the other vehicle 400, and the user device is not limited to the above-described embodiment.

FIG. 2 is a diagram showing modules constituting a vehicle according to one embodiment of the present disclosure.

The vehicle 100 may include a sensor unit 102, a manipulation unit 104, a display 106, a load device 108, and a transceiver 110.

The sensor unit 102 may be provided with various types of detectors to detect various states and situations occurring in an external environment, an internal system, driving, a user operation, and a boarding space of the vehicle 100. The sensor unit 102 may also be abbreviated as a sensor, which is a general term for sensor modules provided in the sensor unit 102.

The first sensor unit 102 may be provided with an externally oriented camera 102a, a Light Detection and Ranging (LiDAR) sensor 102b, a radio detection and ranging (RADAR) sensor 102c, and the like, to recognize dynamic and static objects present outside the vehicle 100. The camera 102a may recognize an external object as an image while the vehicle 100 is in use, generate image data, and transmit the image data to the processor 120. The camera 102a may be disposed on a plurality of parts of the vehicle body, for example, to provide a surround view which may recognize the environment around the vehicle 100. The LiDAR sensor 102b may generate point cloud data as recognized data of the external object and transmit the point cloud data to the processor 120 to generate 3D spatial information that identifies at least a shape of the external object. To ascertain the presence of an external object and its relative distance, speed, direction, or the like, the radar sensor 102c may emit radio waves of a specific frequency around the vehicle 100 and generate radar data through radio waves reflected from the external object. In an exemplary embodiment of the present disclosure, the sensor unit is illustrated as including the LiDAR sensor 102b, but in other examples, the LiDAR sensor 102b may not be disposed.

The sensor unit 102 may further include a positioning sensor 102d, a wheel sensor 102e, and an attitude sensor 102f. The positioning sensor 102d is a module that identifies the position of the vehicle 100 and may include, for example, a Global Positioning System (GPS) sensor or a GNSS sensor. The wheel sensor 102e may detect a wheel speed of a wheel, a wheel rotation angle, a wheel rotation angular velocity, a steering wheel angle, a steering wheel rotation angular velocity, and the like. The attitude sensor 102f may detect a state of the vehicle 100 in each of three axes, such as yaw, pitch, and roll, and output various attitude states of the vehicle based on the above-described parameters. The attitude sensor 102f may include, for example, an inertial measurement unit (IMU) sensor, a gyro sensor, and the like.

In an exemplary embodiment of the present disclosure, the sensors of the sensor unit 102 referred to in the description of the exemplary embodiment are mainly described, but sensors that detect various situations not listed therein may be additionally included.

The manipulation unit 104 may be configured as a module which is controlled by the user for driving. For example, the manipulation unit 104 may be a steering wheel for manual driving, a directional automatic or manual shift actuator, an accelerator pedal, a brake pedal, a transmission, a turn indicator for notifying nearby vehicles and pedestrians of a turning direction, or the like. The turn indicator may be provided as hardware, such as a lever or button, or as a user interface, such as a soft key.

Furthermore, the manipulation unit 104 may be further provided with an interface for enabling or disabling an autonomous driving mode and selecting detailed functions requested by the user so that the user may use an autonomous driving function. To receive various requests related to autonomous driving, the manipulation unit 104 may be configured, for example, as a hard-type interface provided at a predetermined position inside the vehicle 100, or as a soft-type interface which may be touched on the display 106.

The display 106 may be configured as a user interface. The display 106 may be displayed by the processor 120 to output an operating state of the vehicle 100, a control state, path/traffic information, remaining energy information (e.g., remaining power information such as remaining fuel amount information, remaining charge amount information, and the like), surrounding environment images obtained from the camera 102a, content requested by the driver, or the like. The surrounding environment image may be a surround view from a camera at a specific view point or from a plurality of cameras. Furthermore, the display 106 may be configured as a touch screen configured for detecting a driver's input to receive a driver's request to instruct the processor 120.

The load device 108 is disposed on the vehicle 100 and may be a type of non-driving electrical device not including a driving power system such as the wheel driving unit 116 or the like. The load device 108 is an auxiliary device that receives electric power from the power source unit 112, and may be, for example, an air conditioning system, a lighting system, a seat system, various devices disposed in the vehicle 100, or the like.

The transceiver 110 may support mutual communication with the server 200, the ITS device 300, nearby vehicles 400, and the like. The transceiver 110 may include a module that processes, for example, cellular communication, WAVE communication, DSRC, and the like. In an exemplary embodiment of the present disclosure, the transceiver 116 may transmit data generated or stored while driving to the server 200 and receive data and software modules transmitted from the server 200. The transceiver 116 may support communication with an electronic device carried by an occupant inside the vehicle 100. In an exemplary embodiment of the present disclosure, the vehicle 100 may transmit and receive data utilized in a method according to an exemplary embodiment of the present disclosure to or from the outside through the transceiver 116.

Furthermore, the vehicle 100 may include the power source unit 112 and the actuating unit 114.

The power source unit 112 may be configured to generate and supply power and electric power used in a driving power system such as the actuating unit 114 and a non-driving power system. The non-driving power system may include, for example, the sensor unit 102, the manipulation unit 104, the display 106, the load device 108, and the transceiver 110. Without being limited thereto, the non-driving power system may include various components implementing sensing, interfacing, communication, and convenience functions, excluding components directly involved in driving operations. When the vehicle 100 is driven based on electrical energy, the power source unit 112 may be configured as an electric battery charged from the outside thereof, or configured as a combination of an electric battery and a fuel cell that charges the electric battery. In the case of a vehicle driven based on the combination of the electric battery and the fuel cell, the power source unit 112 may include a tank that stores materials used to produce electric power for the fuel cell, such as liquefied hydrogen. When the vehicle 100 is driven based on fossil energy, the power source unit 112 may be configured as an internal combustion engine. Furthermore, when the vehicle 100 is a hybrid type, the power source unit 112 may be provided as a combination of the internal combustion engine and the electric battery.

The actuating unit 114 may be provided with at least one module that implements driving operations and perform at least one driving operation among longitudinal control such as acceleration and deceleration and lateral control such as steering, according to a user request from the manipulation unit 104. To perform driving operations according to a command of the processor 120 by manual operation of the user or autonomous driving, the actuating unit 114 may be provided with the wheel driving unit 116 and mechanical components and electronic modules for implementing the driving operations in the wheel driving unit 116. When the vehicle 100 is operated based on electrical energy, the actuating unit 114 may include an assembly for transmitting the requested driving operation to the wheel driving unit 116. When the vehicle 100 is operated based on fossil energy, the actuating unit 114 may be provided with a transmission and a gear module that transmit the power of the internal combustion engine.

The wheel driving unit 116 may include a plurality of wheels, a driving force generation module for generating a driving force and applying the driving force to the wheels or transmitting the driving force, a braking module for slowing down the driving of the wheels, and a steering module for carrying out lateral control of the wheels. When the vehicle 100 is driven based on electrical energy, the driving force generating module may be configured as a motor assembly that generates a driving force based on electric power output from the electric battery. The braking module of the electric-based vehicle 100 may further include a regenerative braking function.

Furthermore, the vehicle 100 may include a memory 118 and the processor 120.

The memory 118 may store applications and various types of data for controlling the vehicle 100, and load applications or read and record data by a request of the processor 120. In an exemplary embodiment of the present disclosure, the memory 118 may store an application and at least one instruction for correcting keypoint information generated by recognizing a nearby object of the vehicle 100. Furthermore, the memory 118 may store or manage various pieces of information and data required for the application and instructions.

For example, the memory 118 may store map information and traffic information to establish a path to a destination requested by the user through a navigation application provided on the display 106. The map information may include road types, road structures, road limit information, traffic marking information, and the like, and may be a road-level low-precision map and/or a lane-level high-precision map. The traffic information may include, for example, a traffic condition around the vehicle 100, a traffic situation on the road, accident information, weather information on the road, and the like. The map information and the traffic information may be stored in the server 200, and the server 200 may transmit the map information related to the path established by the user request and related traffic information to the vehicle 100, so that the memory 118 may manage the related information, that is, the map information and the traffic information. In another example, the traffic conditions around the vehicle 100 may be established based on the surrounding environmental conditions obtained by the sensor unit 102 or vehicle to vehicle (V2V), differently from other traffic information.

Furthermore, the memory 118 may manage vehicle data generated while driving. The vehicle data may include, for example, a longitudinal control state of the vehicle 100, a lateral control state, an attitude state of the vehicle 100, surrounding environment data obtained by the sensor unit 102, and data related to autonomous driving control. The longitudinal control state may have, for example, driving speed, acceleration, and deceleration. The longitudinal control state listed as examples in the above description may form the longitudinal information in an exemplary embodiment of the present disclosure. The lateral control state may include, for example, a steering wheel rotation angle, a steering wheel rotation angular velocity, and the like. The lateral control state listed as examples in the above description may form lateral information related to steering of the vehicle 100 in an exemplary embodiment of the present disclosure. The attitude state may be, for example, a tilt state of the vehicle 100 based on the state of the vehicle 100 in each of three axes while the vehicle is traveling or stopped. The attitude state may form attitude information related to the attitude of the vehicle in an exemplary embodiment of the present disclosure.

The longitudinal control state, the lateral control state, and the attitude state may be obtained by utilizing or analyzing Controller Area Network (CAN) data generated while driving from an electric power unit (EPU) constituting, for example, the wheel sensor 102e, the attitude sensor 102f, and the processor 120.

The processor 120 may perform overall control of the vehicle 100. The processor 120 may be configured to execute the application and instructions stored in the memory 118.

In relation to the present disclosure, the processor 120 may perform processing to generate a bird's-eye view image based on image data that obtains the surrounding environment of the vehicle 100. The processor 120 may execute processing to generate keypoint information including a keypoint detected from a nearby object of the vehicle 100 based on the bird's-eye view image. Furthermore, in response to the driving of the vehicle 100, the processor 120 may perform processing to generate a first movement amount identified by the keypoint information and a second movement amount identified by vehicle data generated by the driving of the vehicle 100. The processor 120 may implement processing to estimate the height of the keypoint in response to a deviation between the first movement amount and the second movement amount. The processor 120 may execute processing to correct keypoint information based on the estimated height of the keypoint.

In an exemplary embodiment of the present disclosure, the processor 120 is exemplified as including a single processing module for executing the above-described processing. As an exemplary embodiment of the present disclosure, the processor 120 may be constituted by a plurality of processing modules, and the processing may be distributed and performed in a plurality of modules.

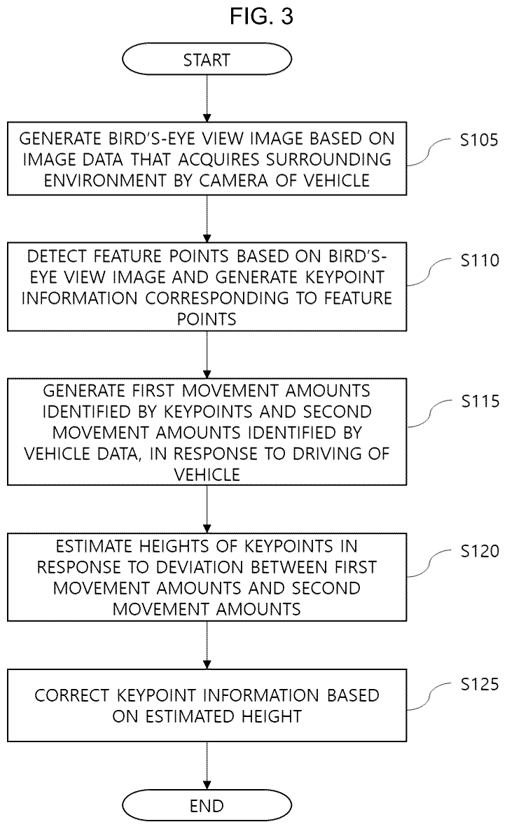

The aforementioned processing of the processor 120 will be described in detail with reference to FIGS. 3 to 8.

Hereinafter, a method of correcting a keypoint according to an exemplary embodiment of the present disclosure will be described with reference to FIGS. 3 to 8. FIG. 3 is a flowchart of a method of correcting a keypoint according to another embodiment of the present disclosure. The present disclosure exemplifies autonomous driving of the vehicle 100 as being performed in a parking situation. However, the exemplary embodiment of the present disclosure may also be practically applied to a driving situation on a typical road including road markings such as traffic markings, in addition to the parking situation. Here, traffic markings may be, for example, lane lines, arrows indicating traveling directions, no-driving/no-parking zones, crosswalks, intersection-related signs, and the like. Furthermore, the processor 120 performing the method according to an exemplary embodiment of the present disclosure may be described interchangeably with the vehicle 100 for convenience of description.

First, the vehicle 100 may be configured to generate a bird's-eye view image based on image data that obtains the surrounding environment of the vehicle 100 by the processor 120 (S105).

The image data may be obtained by a plurality of cameras 102a, and the plurality of cameras may be disposed on the vehicle 100 to have, for example, different viewpoints. The bird's-eye view image may be generated based on a plurality of pieces of image data obtained from the plurality of cameras 102a.

The bird's-eye view image is an image obtained by combining the plurality of pieces of image data to form a view from above the vehicle 100 toward the ground, and may also be referred to as a bird's-eye view (BEV). The processor 120 may perform fusion processing on a plurality of pieces of image data including different viewpoints to generate a bird's-eye view image. The fusion processing may include a process of matching a plurality of images with each other, performing calibration of the plurality of images based on a unified specific coordinate system, and combining the plurality of images in the same coordinate system. The specific coordinate system applied to a bird's-eye view image may be referred to as an image coordinate system in an exemplary embodiment of the present disclosure.

The image data of each camera 102a is defined according to its own unique coordinate system, and an object of each piece of image data may be described with a position according to the unique coordinate system, for example, a position value by a pixel value. The object of each piece of image data is transformed into a position based on the unified image coordinate system through fusion processing, and may be specified as a position value of the bird's-eye view image, for example, a pixel value of a bird's-eye view image.

The bird's-eye view image may be generated, for example, by a conventional projection function or a transformation model based on machine learning. The bird's-eye view image formed in the above manner may be generated so that all objects have the same height level in the image. The same height level may be, for example, 0 (Z=0). The bird's-eye view image may be formed so that not only the ground in the image but also an object extending upwards from the ground have a height of 0.

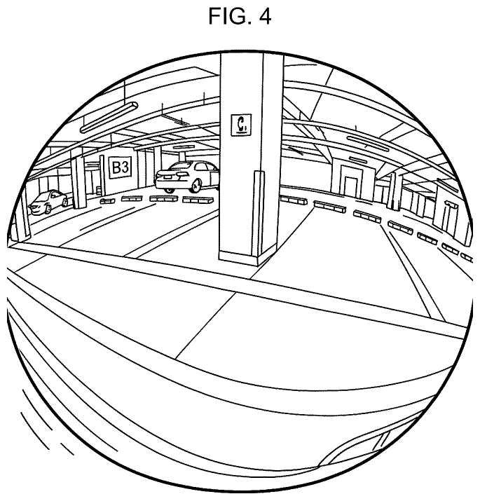

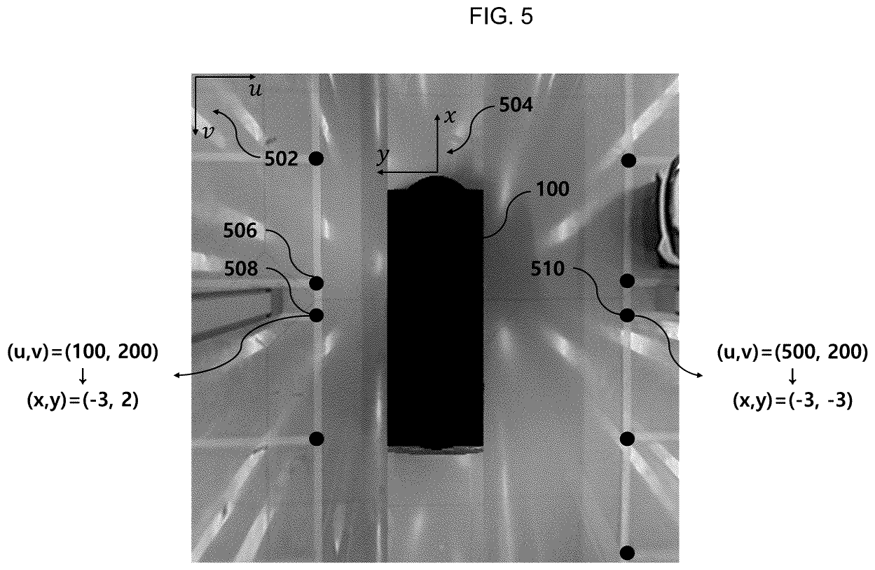

FIG. 4 is a view exemplarily illustrating an image of the surrounding environment obtained by the camera of the vehicle. As illustrated in FIG. 4, an image captured by the camera 102a including a specific viewpoint includes a vertical pillar. A bird's-eye view image generated based on the image of FIG. 4 shows a vertical pillar with a height of 0, as illustrated in FIG. 5, so that the vertical pillar is expressed in a different position in the bird's-eye view image from its actual position. FIG. 5 is a view exemplarily illustrating the bird's-eye view image.

Furthermore, the bird's-eye view image in FIG. 5 is expressed assuming that the ground is at the same height level, for example, a point at height 0, as described above. However, even when the flatness of the ground is uneven and one point on the ground has a greater height than other points, the bird's-eye view image may be depicted differently from an actual ground condition to have the same height level at all points on the ground. That is, an object on the ground and the ground with uneven heights may appear in different positions from their actual positions in the bird's-eye view image. When the object and the ground are referred to as nearby objects, the bird's-eye view image may be generated to have distortion that does not correspond to the actual position and shape of the nearby objects.

Next, the processor 120 of the vehicle 100 may detect feature points from the nearby objects of the vehicle 100 based on the bird's-eye view image and generate keypoint information including keypoints corresponding to the feature points (S110).

The processor 120 may detect a plurality of feature points from the nearby object appearing in the bird's-eye view image using a feature point extraction model, as illustrated in FIG. 5. The feature point extraction model may be, for example, a machine learning model that detects feature points from an image. The machine learning model may utilize networks based on convolutional neural networks (CNNs) or recurrent neural networks (RNNs). The machine learning model is not limited to the networks exemplified above and may be composed of various types of deep learning networks.

The nearby objects detected by the feature point extraction model are static objects, and the processor 120 may identify predetermined portions of the static objects using the feature point extraction model and employ the identified portion as feature points. The static object is, for example, a road marking. The road marking may be a traffic marking displayed on a parking lot or road. The road marking in a parking lot may be lines on the parking lot, while the road marking on a general road may be lane lines, arrows indicating a traveling direction, no-driving/no-parking zones, crosswalks, or intersection markings.

The feature point may be, for example, at least one of an end portion of a static object, an edge portion of the static object, a vertex of the static object, and an intersection located at a point where lines of different static objects meet. For example, in relation to the end portion of the static object, a feature point may be detected at the end portion of a lane line based on a longitudinal direction of the lane line that functions as a traffic marking on a road. For example, in relation to the edge portion of the static object, a feature point may be detected on some of outermost lines (or corners or edge portions) of a lane line. For example, in relation to the vertex of the static object, a feature point may be detected at some of vertices of a lane line. In FIG. 5, it is illustrated that lines of the parking lot are identified as static objects, and intersections located at a point where the lines meet are detected as feature points 506, 508, and 510. The selection of static objects and extraction of feature points are not limited to the example in FIG. 5. Specifically, another road marking may be selected, or a feature point may be detected as at least one of the elements listed above. As an exemplary embodiment of the present disclosure, the static object may be another type of object other than the road marking, such as a pillar or a structure on the road as illustrated in FIG. 5.

The processor 120 may check the positions of the feature points 506, 508, and 510 based on an image coordinate system 502 applied to the bird's-eye view image and store the positions of feature points 506, 508, and 510 in the memory 118. The position may be, for example, a position value according to a unique coordinate of the image coordinate system 502 or a pixel value of the image coordinate system 502 that employs a pixel value of the bird's-eye view image. In FIG. 5, the origin of the image coordinate system 502 is illustrated as one point at the upper left of the bird's-eye view image, and the positions of feature points 506, 508, and 510 are illustrated as (u, v) coordinates.

Thereafter, the processor 120 of the vehicle 100 may be configured to generate keypoint information including a keypoint corresponding to at least one of the plurality of feature points 506, 508, and 510.

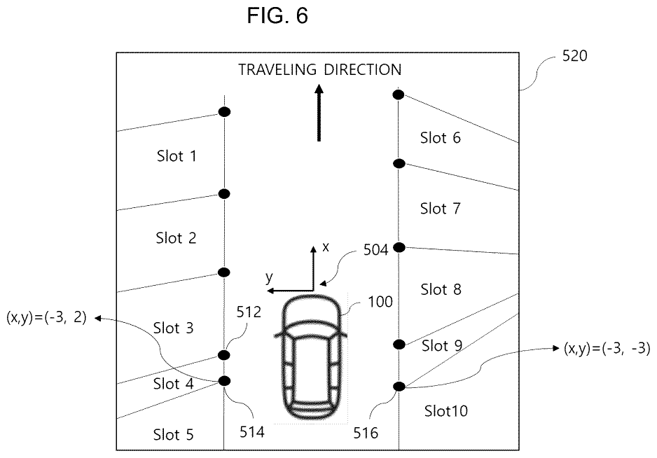

The keypoint may be formed by employing all or some of a plurality of feature points. The processor 120 may be configured to generate keypoint information including keypoints 512, 514, and 516 generated by projecting the feature points 506, 508, and 510 onto a keypoint coordinate system 504. As illustrated in FIG. 6, keypoint information 520 may include positions, that is, the position values or coordinate values, of the keypoints 512, 514, and 516 in the keypoint coordinate system 504. FIG. 6 is a view exemplarily illustrating the keypoint information. The keypoint coordinate system 504 is different from the image coordinate system 502 of the bird's-eye view image as illustrated in FIG. 5, and may be a coordinate system established based on a predetermined portion of the vehicle 100 as illustrated in FIGS. 5 and 6. The predetermined portion is the origin of the keypoint coordinate system 504 and is illustrated as the center portion of a front portion of the vehicle in FIG. 6. The keypoint coordinate system 504 may be a world coordinate system. However, without being limited thereto, the origin of the keypoint coordinate system 504 may be variously designated, such as a central point between the rear wheels, a center of gravity, or the like.

Since the keypoint information 520 is generated based on the bird's-eye view image, the keypoints 512, 514, and 516 may be initially generated to have the same height level. The same height level may be, for example, 0 (Z=0). The keypoint coordinate system 504 in FIGS. 5 to 8 is expressed in two dimensions for convenience of illustration and does not indicate a three-dimensional axis Z, but is actually a coordinate system including three dimensions and may be expressed in three dimensions including the Z axis depending on embodiments. The position values of the keypoints 512, 514, and 516 to be described below in FIGS. 5 to 8 are described in two dimensions for convenience of description, but when the height is not the initially set height (that is, Z=0), it may be described in three dimensions.

A method of projecting the feature points 506, 508, and 510 of the image coordinate system 502 to the keypoint coordinate system 504 may utilize, for example, a mathematical transformation model between two coordinate systems 502 and 504. The mathematical transformation model may be a translation model between two coordinate systems 502 and 504. By the projection, the feature points 506, 508, and 510 may be transformed into the keypoints 512, 514, and 516 including position values in the keypoint coordinate system 504, and the keypoints 512, 514, and 516 may be generated to correspond to the feature points 506, 508, and 510. Furthermore, the corresponding positions of the feature points 506, 508, and 510 and the keypoints 512, 514, and 516 may be stored in the memory 118. As illustrated in FIGS. 5 and 6, the positions of the keypoints 512, 514, and 516 are composed of (x, y) coordinates. For example, the position (u=100, v=200) of the feature point 508 according to the image coordinate system 502 may be transformed into the position (x=−3, y=2) of the keypoint 514 according to the keypoint coordinate system 504 by projection. The position (u=500, v=200) of the feature point 510 according to the image coordinate system 502 may be transformed into the position (x=−3, y=−3) of the keypoint 516 according to the keypoint coordinate system 504 by projection.

Next, the processor 120 may be configured to generate a first movement amount identified by the keypoint information 520 and a second movement amount identified by vehicle data generated by driving of the vehicle, in response to the driving of the vehicle 100 (S115).

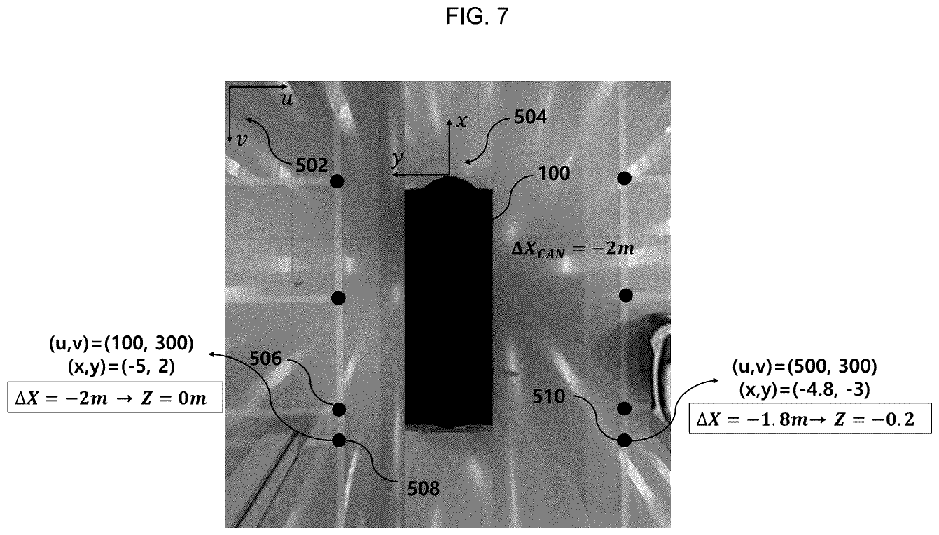

First, when describing the generation of the first movement amount, the processor 120 may analyze the bird's-eye view image which is changed depending on the driving of the vehicle 100, that is, the movement of the vehicle 100. The processor 120 may identify changes in positions of the feature points that correspond to the keypoints 512, 514, and 516 and are changed by the movement of the vehicle 100 in the bird's-eye view image. As illustrated in FIG. 7, since the image coordinate system 502 of the bird's-eye view image moves as the vehicle 100 travels and the position of each of the feature points 506, 508, and 510 corresponding to the keypoints 512, 514, and 516 is changed as the image coordinate system 502 moves, the processor 120 may be configured to determine the positions of change of the feature points 506, 508, and 510. The determination of the positions of change may be performed on the feature points 506, 508, and 510 corresponding to all keypoints 512, 514, and 516 included in the keypoint information 520. FIG. 7 is a view exemplarily illustrating a bird's-eye view image which is changed according to driving of the vehicle. Taking FIG. 7 as an example, the position of the feature point 508 is changed from (u, v)=(100, 200) to (u, v)=(100, 300) by the movement of the vehicle 100, and the position of the feature point 510 is changed from (u, v)=(500, 200) to (u, v)=(500, 300).

Thereafter, the processor 120 may be configured to determine the positions of change of the keypoint by projecting the positions of change of the feature points 506, 508, and 510 onto the keypoint coordinate system 504. The projection method may be substantially the same as described in operation S110. As illustrated in FIG. 7, a changed value (u=100, v=300) of the feature point 508 may be transformed into the changed position (x=−5, y=2) of the keypoint 514 according to the keypoint coordinate system 504 by projection. The changed position (u=500, v=300) of the feature point 510 may be transformed into the changed position (x=−4.8, y=−3) of the keypoint 516 according to the keypoint coordinate system 504 by projection. In the present example, for the convenience of illustration, the positions of change of the keypoints 512, 514, and 516 are displayed on the bird's-eye view image, but the transformation of the positions of change may be processed using the bird's-eye view image of FIG. 7 and the keypoint information 520 of FIG. 6.

Subsequently, the processor 120 may be configured to generate the first movement amount based on the positions of change of the keypoints 512, 514, and 516. The first movement amount may be determined as a distance between an initial position (the keypoint position illustrated in FIGS. 5 and 6) and the changed position (the keypoint position illustrated in FIG. 7) of each of the keypoints 512, 514, and 516, and may be determined for all the keypoints 512, 514, and 516 included in the keypoint information 520. In FIG. 7, the first movement amounts ΔX according to the changed position of each of the keypoints 514 and 516 is exemplified as −2 m and −1.8 m, respectively.

Next, when describing the generation of the second movement amount, the processor 120 may be configured to generate the second movement amount based on vehicle data generated by the driving of the vehicle, that is, the movement of the vehicle 100.

The vehicle data may include, for example, longitudinal information including the speed of the vehicle 100, acceleration of the vehicle 100, and deceleration of the vehicle 100, lateral information related to steering of the vehicle 100, and attitude information related to the attitude of the vehicle. For example, the longitudinal information and the lateral information may be generated by the wheel speed and steering wheel rotation angle obtained by the wheel sensor 102e. The attitude information may be obtained by the attitude sensor 102f, for example, an IMU sensor, and may have a state for each of three axes. In FIG. 7, the second movement amount between the initial position and the changed position, that is, the second movement amount ΔX_{CAN} identified by the vehicle data, is exemplified as −2 m.

Referring again to FIG. 3, the processor 120 of the vehicle 100 may estimate heights of the keypoints 512, 514, and 516 in response to deviations between the first movement amounts and the second movement amounts (S120).

When there is a plurality of keypoints 512, 514, and 516, the processor 120 may be configured to determine whether a deviation is present between the first movement amount and the second movement amount for each of the keypoints 512, 514, and 516. Accordingly, the processor 120 may distinguish between the keypoint 514 and 516 for which a deviation is present and the keypoint 512 for which a deviation is not present. Taking FIG. 7 as an example, since the second movement amount ΔX_{CAN} is −2 m and the first movement amount ΔX of the keypoint 516 is −1.8 m, the processor 120 may be configured to determine that the keypoint 516 is a keypoint including a deviation. Since the second movement amount ΔX_{CAN} is −2 m and the first movement amount ΔX of the keypoint (514) is −2 m, the processor 120 may be configured to determine that the keypoint 514 is a keypoint that has no deviation.

Thereafter, the processor 120 may estimate the height of the keypoint in the keypoint coordinate system 504 for the keypoint 516 including a deviation. The height of the keypoint for which a deviation is present may be estimated based on the first movement amount, the second movement amount, the keypoint information 520 related to the keypoint 516 for which a deviation is present, and the feature point 510 corresponding to the keypoint 516 for which a deviation is present in the bird's-eye view image. Here, the keypoint information and the feature point may include, for example, the position of the keypoint 516 and the position of the feature point 510.

Furthermore, the height of the keypoint 516 may be estimated using either a trigonometric function model or a pinhole camera model. The model may estimate the height of the keypoint 516 for which a deviation is present using at least one of the data and information listed above.

Meanwhile, the processor 120 may not apply height estimation to the keypoint 514 for which no deviation occurs, and may maintain the height of the keypoint 514 without changing the height.

Next, the processor 120 may correct the keypoint information 520 based on the estimated height of the keypoint 516 due to the presence of the deviation (S125).

As illustrated in FIGS. 6 and 7, the heights of the keypoints 512 and 516 are newly estimated by the deviation, and the height of the keypoint 514 is maintained due to the absence of the deviation. The processor 120 may change at least a portion of the keypoint information 520 based on data of the keypoints 512, 514, and 516 including newly estimated heights, for example, positions and heights of the keypoints 512, 514, and 516.

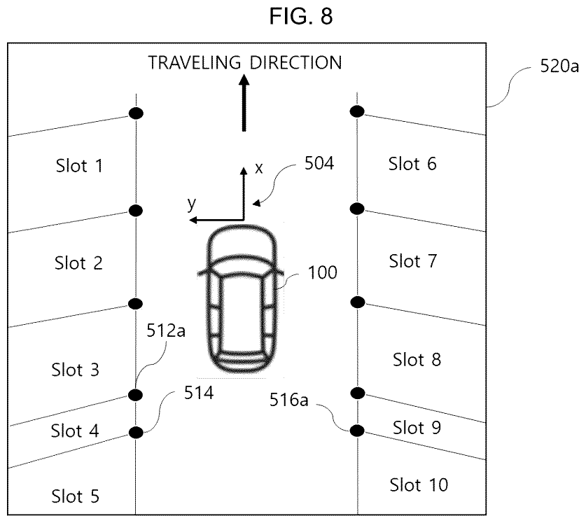

As illustrated in FIG. 8, the keypoint 512 and 516 whose heights are newly estimated due to the deviation may be provided with corrected keypoints 512a and 516a by reflecting the heights in position values, so that corrected keypoint information 520a may be generated. FIG. 8 is a view exemplarily illustrating keypoint information including corrected keypoints. In contrast, the keypoint 514 for which the deviation is absent may include an initial position value and an initial height without correction of the height. The processor 120 may correct keypoint information based on the corrected keypoints 512a and 516a and the maintained keypoint 514. In the instant case, the heights of the feature points 506 and 510 corresponding to the corrected keypoints 512a and 516a may not be corrected in the bird's-eye view image. That is, even when feature points corresponding to the keypoints for which the deviation occurs are present, the bird's-eye view image may not be corrected. This may be because the data actually used to control autonomous driving is keypoint information. According to an exemplary embodiment of the present disclosure, the accuracy of path generation and autonomous driving performance may be improved through accurate estimation of the height of an object around the vehicle.

According to an exemplary embodiment of the present disclosure, it is possible to provide a method and vehicle for correcting a keypoint can improve the accuracy of path generation and autonomous driving performance through accurate estimation of the height of an object around the vehicle.

The effects obtainable from the present disclosure are not limited to the effects mentioned above, and other effects not mentioned may be clearly understood by those of ordinary skill in the art to which the present disclosure belongs from the following description.

While the exemplary methods of the present disclosure described above are represented as a series of operations for clarity of description, it is not intended to limit the order in which the steps are performed, and the steps may be performed simultaneously or in different order as necessary. To implement the method according to an exemplary embodiment of the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

Furthermore, various embodiments of the present disclosure may be implemented in hardware, firmware, software, or a combination thereof. In the case of implementing the present disclosure by hardware, the present disclosure may be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

What is claimed is:

1. A method of correcting a keypoint, the method comprising:
generating, by a processor, a bird's-eye view image based on image data that obtains a surrounding environment of a vehicle;
generating, by the processor, keypoint information including a keypoint detected from a nearby object of the vehicle based on the bird's-eye view image;
generating, by the processor, in response to driving of the vehicle, a first movement amount identified by the keypoint information and a second movement amount identified by vehicle data generated by the driving of the vehicle;
estimating, by the processor, a height of the keypoint in response to a deviation between the first movement amount and the second movement amount;
correcting, by the processor, the keypoint information based on the estimated height of the keypoint; and
controlling the vehicle based on the corrected keypoint information.

2. The method of claim 1, wherein the nearby object is a static object, and the keypoint is generated at at least one of an end portion of the static object, an edge portion of the static object, a vertex of the static object, and an intersection located at a point where lines of different static objects meet.

3. The method of claim 2, wherein the static object is a road marking.

4. The method of claim 1, wherein a keypoint coordinate system of the keypoint information is different from an image coordinate system of the bird's-eye view image and is a coordinate system established based on a predetermined portion of the vehicle.

5. The method of claim 1,
wherein the generating of the keypoint information includes generating the keypoint information including the keypoint generated by detecting a feature point recognized from the nearby object of the bird's-eye view image and projecting the feature point onto a keypoint coordinate system, and
wherein the generating of the first movement amount in response to the driving of the vehicle includes:
identifying a changed position of the feature point that corresponds to the keypoint and is changed in the bird's-eye view image by the driving of the vehicle;
projecting the changed position of the feature point onto the keypoint coordinate system to determine a changed position of the keypoint; and
generating the first movement amount based on the changed position of the keypoint.

6. The method of claim 1, wherein the vehicle data includes longitudinal information including speed, acceleration, and deceleration of the vehicle, lateral information related to steering of the vehicle, and attitude information related to an attitude of the vehicle.

7. The method of claim 1, wherein the estimating of the height of the keypoint includes estimating the height of the keypoint for which the deviation is present in a keypoint coordinate system of the keypoint information based on the first movement amount, the second movement amount, the keypoint information related to the keypoint for which the deviation is present, and a feature point corresponding to the keypoint for which the deviation is present in the bird's-eye view image, and the height of the keypoint is estimated using either a trigonometric function model or a pinhole camera model.

8. The method of claim 1, further comprising configuring the keypoint information without changing the height of the keypoint for which the deviation is absent, in response to absence of the deviation between the first movement amount and the second movement amount.

9. The method of claim 1, wherein the generating of the keypoint information includes detecting a plurality of feature points recognized from the nearby object of the bird's-eye view image and generating the keypoint information to include a plurality of keypoints based on the plurality of feature points.

10. The method of claim 1, wherein the bird's-eye view image is generated so that all objects have the same height level in the image.

11. A vehicle that implements keypoint correction, the vehicle comprising:
a sensor unit configured to detect a surrounding environment of the vehicle;
a memory configured to store at least one instruction for controlling the vehicle; and
a processor operatively connected to the sensor unit and the memory and configured to execute the at least one instruction stored in the memory,
wherein the processor is configured to:
generate a bird's-eye view image based on image data that obtains the surrounding environment of the vehicle;
generate keypoint information including a keypoint detected from a nearby object of the vehicle based on the bird's-eye view image;
generate, in response to driving of the vehicle, a first movement amount identified by the keypoint information and a second movement amount identified by vehicle data generated by the driving of the vehicle;
estimate a height of the keypoint in response to a deviation between the first movement amount and the second movement amount;
correct the keypoint information based on the estimated height of the keypoint; and
control the vehicle based on the corrected keypoint information.

12. The vehicle of claim 11, wherein the nearby object is a static object, and the keypoint is generated at at least one of an end portion of the static object, an edge portion of the static object, a vertex of the static object, and an intersection located at a point where lines of different static objects meet.

13. The vehicle of claim 12, wherein the static object is a road marking.

14. The vehicle of claim 11, wherein a keypoint coordinate system of the keypoint information is different from an image coordinate system of the bird's-eye view image and is a coordinate system established based on a predetermined portion of the vehicle.

15. The vehicle of claim 11,
wherein the generating of the keypoint information includes generating the keypoint information including the keypoint generated by detecting a feature point recognized from the nearby object of the bird's-eye view image and projecting the feature point onto a keypoint coordinate system, and
wherein the generating of the first movement amount in response to the driving of the vehicle includes:
identifying a changed position of the feature point that corresponds to the keypoint and is changed in the bird's-eye view image by the driving of the vehicle;
projecting the changed position of the feature point onto the keypoint coordinate system to determine a changed position of the keypoint; and
generating the first movement amount based on the changed position of the keypoint.

16. The vehicle of claim 11, wherein the vehicle data includes longitudinal information including speed, acceleration, and deceleration of the vehicle, lateral information related to steering of the vehicle, and attitude information related to an attitude of the vehicle.

17. The vehicle of claim 11, wherein the estimating of the height of the keypoint includes estimating the height of the keypoint for which the deviation is present in a keypoint coordinate system of the keypoint information based on the first movement amount, the second movement amount, the keypoint information related to the keypoint for which the deviation is present, and a feature point corresponding to the keypoint for which the deviation is present in the bird's-eye view image, and the height of the keypoint is estimated using either a trigonometric function model or a pinhole camera model.

18. The vehicle of claim 11, wherein the processor is further configured to generate the keypoint information without changing the height of the keypoint for which the deviation is absent, in response to absence of the deviation between the first movement amount and the second movement amount.

19. The vehicle of claim 11, wherein the generating of the keypoint information includes detecting a plurality of feature points recognized from the nearby object of the bird's-eye view image and generating the keypoint information to include a plurality of keypoints based on the plurality of feature points.

20. The vehicle of claim 11, wherein the bird's-eye view image is generated so that all objects include the same height level in the image.
